(19) United States
(12) Patent Application Publication
(10) Pub. No.: US 2005/0285956 A1
(43) Pub. Date: Dec. 29, 2005

(54) Color-filter array for an optical-image sensor

(75) Inventors: Michael Wagner, Bretnig-Hauswalde (DE); Peter Rieve, Windeck-Dattenfeld (DE); Konstantin Seibel, Siegen (DE)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics N.V., Schiphol Airport (NL)

(21) Appl. No.: 11/106,359

(22) Filed: Apr. 14, 2005

Related U.S. Application Data
(63) Continuation of application No. 10/495,731.

(30) Foreign Application Priority Data
Nov. 15, 2001 (DE) 10155819.8

(51) Int. Cl. H04N 5/335

(52) U.S. Cl. 348/272

(57) ABSTRACT

A color filter array for an optical image sensor comprising pixels that are arranged in a matrix or a line, each pixel being connected to an electronic circuit for converting the information concerning the luminosity of each pixel into electric signals. A rectangular color filter of a predetermined color is placed over each pixel and several pixels that are directly adjacent form pixel by pixel with color filters of different colors a base cell, a plurality of said base cells together constituting the matricial or linear image sensor. The aim of the invention is to create a color filter array for an optical image sensor, which reliably prevents the distortion of the color signals by unfiltered white light. The object is achieved by making the border regions between adjacent color filters of different color significantly less permeable to light as a result of an overlap or additional non-transparent strips.

The invention relates to a color filter array for an optical image sensor comprising pixels that are arranged in a matrix or a line, each pixel being connected with an electronic circuit for converting the information concerning the luminosity of each pixel into electrical signals, wherein a rectangular color filter of a predetermined color is placed over each pixel and several pixels that are directly adjacent together form a base cell pixel by pixel with filters of varying color, and a plurality of base cells together constitute the matricial or linear image sensor.

Such a color filter array can be used, for example, for TFA image sensors (thin film on ASIC image sensors) to acquire RGB color information, which consists of pixels arranged in a matrix or line. The electronic circuits required for operating the image sensor, such as pixel electronics, peripheral electronics, and system electronics, are usually fabricated using CMOS-based silicon technology, and comprise the application-specific circuit (ASIC).

Separated from the ASIC by an insulating layer and connected with it by electrical contacts (vias), a multi-layer system is arranged on the ASIC as a photodiode, which converts electromagnetic radiation (light) into a photocurrent that depends on the radiation intensity. This photocurrent is transferred to the underlying pixel electronics at specific contacts present in each pixel. Such a TFA image sensor is described in B. Schneider, P. Rieve, M. Böhm, Image Sensors in TFA (Thin Film on ASIC) Technology, ed. B. Jähne, H. Hausecker, P. Geiβler, Handbook of Computer Vision and Applications, pp. 237-270, Academic Press, San Diego, 1999.

Detecting colors with such image sensors usually requires the use of color filters, which are applied to individual image points (pixels). In the simplest case, such color filters for acquiring color information can be fabricated using color coatings, which only allow light to pass in specific wavelength ranges. U.S. Pat. No. 3,971,065 A provides one example for this. Another possibility involves the use of interference filters. RGB (red green blue), CMY (cyan magenta yellow), or some other information from whatever filter method chosen is usually used as the color information.

Obtaining the RGB or CMY color information now requires that the varying colors of the color filters be grouped pixel by pixel in such a way that several closely adjacent pixels yield the color information of a base cell. One simple approach to grouping involves generating a square as the base cell, in which two green filters and one each red and blue filter are provided, diagonally arranged, in the case of RGB filters. Of course, other configurations of the base cell are also conceivable. Placing these base cells side by side now yields a uniform color filter array on an image sensor, e.g., a TFA image sensor.

One essential feature of TFA image sensors is that photoactive areas, here photodiodes, of adjacent image points directly abut each other. An area-filling factor of 100% must be assumed in this case. If a black-and-white sensor is now to be converted into a color sensor by applying a color filter array, white light must under all circumstances be prevented from distorting the color information. It was shown that unfiltered light cannot be prevented from getting to the photodiode in the boundary region between the individual color filters when applying a color filter array without implementing the appropriate technical measures. The result would be a distortion of the RGB, CMY or other color signals.

Therefore, the object of the invention is to provide a color filter array for an optical image sensor that reliably prevents unfiltered white light from distorting the color signals.

The object of the invention is achieved in a color filter array of the kind mentioned at the outset by virtue of the fact that the boundary regions between adjacent filters of varying color have a clearly reduced transparency.

This simple underlying idea makes it possible to reliably prevent distortions caused by penetrating white light using simple means. This tangibly improves the quality of the color signals.

A distinctly reduced color permeability can most easily be achieved in the boundary region by using adjacent color filters of varying color that have an overlap in the boundary regions to reduce transparency.

In an alternative, the boundary regions between the color filters are covered in at least an approximately lightproof manner through the use of nontransparent strips to cover the boundary regions between the color filters.

The nontransparent lightproof strips can consist of metal with a sufficient layer thickness, or absorbent polymer layers.

One special embodiment of the invention is characterized by the fact that a narrow free space is situated between the color filters, filled with an approximately lightproof material. This free space between the color filters of the color filter array can be incorporated after the fact by means of a photolithographic method and subsequent etching.

A metal or other lightproof material of sufficient layer thickness is preferably used as the lightproof material.

The invention will be described below based on an exemplary embodiment. The accompanying drawings show:

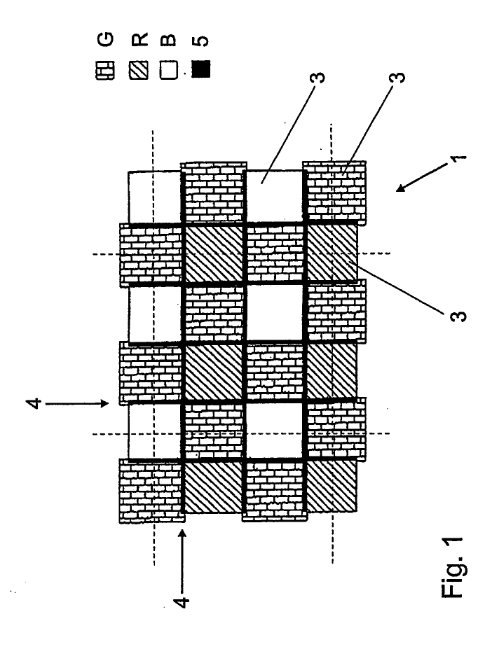

FIG. 1: A top view of a diagrammatic representation of a color filter array with an overlap according to the invention in the boundary region of adjacent color filters;

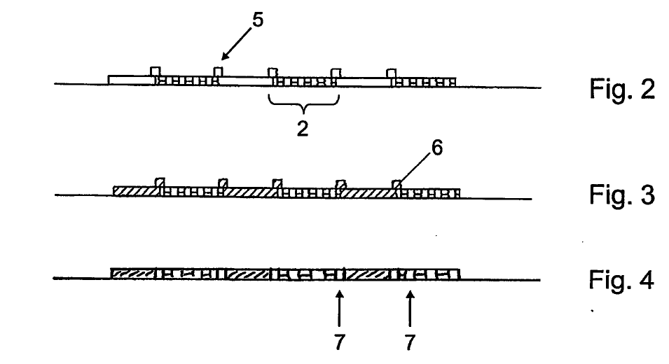

FIG. 2: A cross sectional view of the color filter array according to FIG. 1;

FIG. 3: A cross sectional view of a color filter array with a lightproof cover over the boundary regions between adjacent color filters; and

FIG. 4: A color filter array with metal strips incorporated into a free space between the color filters.

FIG. 1 shows a color filter array 1 for an optical image sensor with a matricial or linear arrangement of pixels 2, which is connected pixel by pixel with an electronic circuit (not shown) to convert the luminance information of each pixel 2 into electrical signals. A rectangular color filter 3 of a predetermined color R (red), G (green) or B (blue) is arranged over each pixel 2. Several directly adjacent pixels 2 here combine with filters of varying color to form a base cell G/G/B/R pixel by pixel, and a plurality of base cells together yield the matricial or linear image sensor.

In the simplest case, the object underlying the invention can be realized using boundary regions 4 between the adjacent color filters 3 of varying color that have a clearly reduced transparency.

Another possibility involves configuring the color filters 3 in such a way that they have an overlap 5 in the boundary regions to adjacent filters (FIGS. 1 and 2).

To prevent the undesirable penetration of white light into the boundary region 4 between the color filter 3, this boundary region 4 between the color filters 3 can be covered in at least an approximately lightproof manner. This cover can take the form of nontransparent strips 6 (FIG. 3). These strips 6 can consist of metal with a sufficient layer thickness, or absorbent polymer layers.

In a special variant of the invention, a narrow free space 7 filled with an approximately lightproof material is located between the color filters (FIG. 4).

### REFERENCE LIST

1 Color filter array
2 Pixel
3 Color filter
4 Boundary region
5 Overlap
6 Nontransparent strip
7 Free space
8 Lightproof material
R Red
G Green
B Blue

1. Color filter array for an optical image sensor comprising pixels that are arranged in a matrix or a line, each pixel being connected with an electronic circuit for converting the information concerning the luminosity of each pixel into electrical signals, wherein a rectangular color filter of a predetermined color is placed over each pixel and several pixels that are directly adjacent together form a base cell pixel by pixel with color filters of varying color, and a plurality of base cells together constitute the matricial or linear image sensor, wherein the boundary regions between the adjacent color filters of varying color have a clearly reduced transparency.

2. Color filter array according to claim 1, wherein the adjacent color filters of varying color have an overlap to reduce transparency in the boundary regions.

3. Color filter array according to claim 1, wherein the boundary regions between the color filters are covered in at least an approximately lightproof manner.

4. Color filter array according to claim 3, wherein the boundary regions between the color filters are covered by nontransparent strips.

5. Color filter array according to claim 4, wherein the lightproof strips comprise metal strips with a sufficient layer thickness.

6. Color filter array according to claim 1, wherein a narrow free space filled with an approximately lightproof material is situated between the color filters.

7. Color filter array according to claim 6, wherein the lightproof material includes metal with a sufficient layer thickness.
